(19) United States
(12) Patent Application Publication
(10) Pub. No.: US 2010/0084844 A1
(43) Pub. Date: Apr. 8, 2010

(54) WINDSHIELD WASHER NOZZLE COVER

(76) Inventor: Steven A. Dringenberg, Camino, CA (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/246,538

(22) Filed: Oct. 7, 2008

(51) Int. Cl. B60S 1/46; B60J 11/06

(52) U.S. Cl. 280/770; 239/288.3; 239/284.1; 239/602

(57) ABSTRACT

A windshield washer nozzle cover for concealing an external windshield washer nozzle disposed on the exterior surface of a vehicle, the windshield washer nozzle cover being molded into a shape different than the contour of the windshield washer nozzle, wherein the shape is configured in the form of indicia to provide non-verbal communication to others.

### TECHNICAL FIELD

Generally, the present invention relates to a windshield washer nozzle cover. More particularly, the present invention relates to a windshield washer nozzle cover that is molded into a shape different than the contour of the windshield washer nozzle itself, the nozzle cover being configured in the form of indicia, such as letters, numbers, symbols, characters, emblems, insignia, logos, tokens, and combinations thereof, to provide non-verbal communication to others.

### BACKGROUND ART

Vehicles are often produced with windshield washer nozzles, also referred to as windshield washer jets or sprayers, which protrude out from the vehicle's external surface, often from the hood of the vehicle. These vehicles may include all types of sedans, sports cars, and utility type vehicles such as off-road vehicles, and other sport-utility vehicles. The purpose of these nozzles is to provide cleaning fluid to a windshield. Generally, vehicles employ at least one or, more typically, two such windshield washer nozzles on the hood of the car. Vehicles may also employ such a nozzle or nozzles to provide cleaning fluid to the rear window.

Some owners of these vehicles believe that the utilitarian aspects of exposed windshield washer nozzles generally detract from the vehicle's appearance. Therefore, it is sometimes desirable to cover such protrusions to mask the appearance of the nozzles. Some owners also believe that covering the nozzles helps to protect them from weathering, tampering, or physical damage.

Thus, manufacturers have attempted to meet the demands of these owners. With respect to those owners desiring better aesthetics for their vehicles, manufacturers have developed replacement nozzles. These nozzles actually replace the factory installed nozzles and may include LED lighted nozzles, which give a glowing effect in a variety of colors in night driving conditions. However, it is necessary to remove the factory nozzle by disconnecting the cleaning fluid feed tube, and then installing the lighted nozzle device. This requires also wire-tying the leads to the supply lines and running them down to just above the grommet in the firewall.

Other manufacturers have attempted to serve the desires of vehicle owners who want to protect these nozzles from the effects of the environment as well as for aesthetic purposes by providing covers for the windshield washer nozzles. Thus, windshield washer nozzle covers do exist. However, to date, all known windshield washer nozzle covers have been molded into a shape that matches or is complementary to the shape of the windshield washer nozzles themselves. Thus, while easier to install and more protective against environmental conditions than replacement nozzles, these nozzle covers lack an ability to provide non-verbal communication to others.

Thus, a need exists for an economical means to cover the windshield washer nozzles, yet at the same time, provide an aesthetically pleasing shape to further personalize or customize the vehicle and provide non-verbal communication to others. The windshield washer nozzle covers of this invention may be molded into a shape different from that of the windshield washer nozzle itself, and in the form of indicia, including but not limited to letters, numbers, symbols, characters, emblems, insignia, logos, tokens, and combinations thereof, to provide the vehicle owner with a desired custom car look that intuitively communicates something to others.

### SUMMARY OF INVENTION

Any one or more of the foregoing aspects of the present invention, together with the advantages thereof over the known art relating to windshield washer nozzle covers and, particularly, nozzle covers molded in the form of indicia such as letters, numbers, symbols, characters, emblems, insignia, logos, tokens, and combinations thereof, and which may be additionally etched or engraved, which shall become apparent from the specification and drawings that follows, may be accomplished by the invention as hereinafter described and claimed.

In general, the present invention provides a windshield washer nozzle cover for concealing an external windshield washer nozzle disposed on the exterior surface of a vehicle, the windshield washer nozzle cover being molded into a shape different than the contour of the windshield washer nozzle, wherein the shape is configured in the form of indicia to provide non-verbal communication to others.

One or more other aspects of the present invention may be achieved by a windshield washer nozzle cover for concealing an external windshield washer nozzle having a spray outlet and disposed on the exterior surface of a vehicle, the windshield washer nozzle cover comprising: an interior surface defining a cavity to accommodate the windshield washer nozzle; an exterior surface having a contour different than that of the windshield washer nozzle, wherein the contour is configured in the form of indicia to provide non-verbal communication to others; and an edge surface communicating between the interior surface and the exterior surface and defining the periphery of the interior surface and the exterior surface and an opening to permit the spray outlet of the windshield washer nozzle to emit fluid.

Still one or more other aspects of the present invention may be achieved by a vehicle comprising at least two windshield washer nozzles, the windshield washer nozzles being spaced apart, each windshield washer nozzle having a windshield washer nozzle cover molded into a shape different than the contour of the windshield washer nozzle, wherein the shape is configured in the form of indicia to provide non-verbal communication to others.

Advantageously, it will be appreciated that, in at least one of the embodiments of the present invention, a windshield washer nozzle cover of the present invention provides for the non-verbal communication to others. Non-verbal communication to others is provided where a nozzle cover is configured into a shape or has a contour that relays an idea, connotation, impression, or expression to others upon viewing the nozzle cover that is different from the idea of simply being a nozzle cover. For example, covers in the form of a letters may provide one or more initials of the owners or an initial of the type of vehicle. Covers in the form of numbers may provide for the residential address of the owner or the number of the vehicle owned. Covers in the form of symbols, characters, emblems, insignia, logos, tokens, and combinations thereof may provide for the corporate ownership of the vehicle by providing the corporate logo or, in another embodiment, may express an emotion or provide an impression, e.g., such as a heart-shaped cover providing the impression that the owner loves his or her vehicle or an emblem demonstrating the owner's support for a favorite athletic team or university affiliation.

### BRIEF DESCRIPTION OF THE DRAWINGS

One or more aspects or advantages of the present invention may become apparent from the subsequent detailed description of the preferred embodiment and the appended claims taken in conjunction with the accompanying drawings where:

FIG. 1 is a perspective view of a windshield washer nozzle cover disposed on the external surface of a vehicle in accordance with the concepts of the present invention;

FIG. 2A is a top plan view of another embodiment of a windshield washer nozzle cover in accordance with the concepts of the present invention;

FIG. 2B is a top plan view of yet another embodiment of a windshield washer nozzle cover in accordance with the concepts of the present invention;

FIG. 3A is a front elevation view of a windshield washer nozzle cover disposed over a windshield washer nozzle;

FIG. 3B is a sectional side view of the windshield washer nozzle and nozzle cover taken along the line 3B-3B in FIG. 3A;

FIG. 4A is a front elevation view of another embodiment of a windshield washer nozzle cover disposed over a windshield washer nozzle; and

FIG. 4B is a sectional side view of the windshield washer nozzle and nozzle cover taken along the line 4B-4B in FIG. 4A.

### DETAILED DESCRIPTION OF THE INVENTION

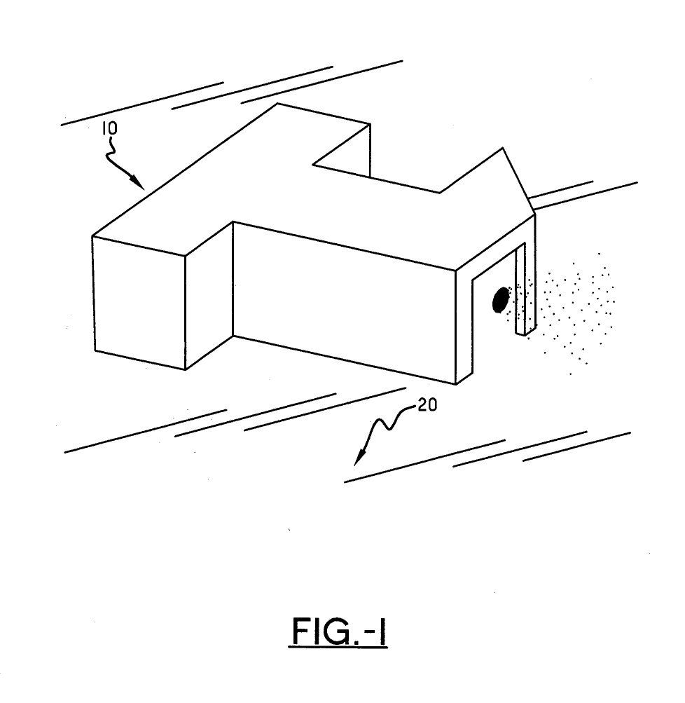

One embodiment of a windshield washer nozzle cover for concealing a windshield washer nozzle, featuring an opening in the cover exposing the portion of the nozzle wherefrom cleaning fluid may be emitted to spray onto the windshield of a vehicle, is generally referred to by the numeral 10 in FIG. 1 of the drawings. Before setting forth the specific structural and functional aspects of the windshield washer nozzle cover, a brief description of the windshield washer nozzle and the environment associated with the windshield washer nozzle, including the vehicle hood, are presented to facilitate understanding of the present invention or the windshield washer nozzle cover's environment with respect to a vehicle.

Many vehicles employ at least one, and generally two, windshield washer nozzles to dispense cleaning fluid onto the external surface of a windshield. Some vehicles also employ one or more windshield washer nozzles in the rear of the vehicle as well. Typically the nozzle functions to dispense liquid from a receptacle which is disposed internally in the vehicle. The windshield washer nozzles, which are connected to the fluid container, are mounted through the external surface of the vehicle and protrude from the external surface of the vehicle, often the hood. It is the protruded portion of the windshield washer nozzle which this invention seeks to conceal without inhibiting the important function of the windshield washer nozzles, namely to spray fluid onto the windshield.

It will be further appreciated that the present invention is limited to those vehicles having windshield washer nozzles which protrude from the exterior surface of the vehicle or the hood of the vehicle, or alternatively as applicable, to rear window washer nozzles protruding from the rear face of the vehicle. Such a windshield washer nozzle is defined as any windshield washer nozzle, also referred to as sprayer or jet, having a configuration that provides for at least a portion of the nozzle to be disposed on or above the exterior surface of a vehicle. The windshield washer nozzle cover of the present invention conceals the nozzle without interfering with the function of the nozzle to emit a cleaning fluid. Also, the windshield washer nozzle cover has a shape or contour different than that of the nozzle itself and, therefore, may provide non-verbal communication to others.

As shown in FIG. 1, the windshield washer nozzle cover 10 is designed for use with a vehicle, which maintains an external body surface 20 which may be a hood or other external surface depending upon the auto manufacturer's placement of the nozzle(s). The windshield washer nozzle cover for concealing an external windshield washer nozzle disposed on the exterior surface of a vehicle may be molded into a shape different than the contour of the windshield washer nozzle itself. The windshield washer nozzle cover 10, as shown in FIG. 1, is molded in the form of indicia, the numeral “1” in this example. Again, the windshield washer nozzle cover is attached to the vehicle in a manner such that the windshield washing cleaning fluid can be emitted from the nozzle and out through the top of the molded indicia nozzle cover onto the windshield. Indicia may include, but is not be limited to, letters, numbers, symbols, characters, emblems, insignia, logos, tokens, and combinations thereof. The windshield washer nozzle cover of the present invention provides non-verbal communication to others.

The windshield washer nozzle cover described herein may be formed from any combination of translucent, transparent, or opaque materials which may include, but is not be limited to, aluminum, steel, and plastic, as are commonly used in the auto industry, or any such material that is capable of protecting the windshield washer nozzle from exposure to the environment. In one embodiment, the windshield washer nozzle cover is molded from billet aluminum. It is also envisioned, wherein the cover is molded from plastic or steel, that the materials utilized in manufacturing the windshield washer nozzle covers of this invention may be colored, texturized, coated, or a combination thereof. In other words, the cover may be treated with any desired ornamental embellishment, indicia, design, or the like. It may therefore be appreciated that the outward appearance of the windshield washer nozzle cover of the invention may come in varied forms. Furthermore, the windshield washer nozzle cover itself may include an exterior surface which has been painted, etched or engraved to incorporate additional indicia into the exterior surface. In one embodiment, the nozzle cover may be molded into the form of indicia, such as a symbol, with additional written indicia painted, etched, engraved or otherwise disposed on the nozzle cover.

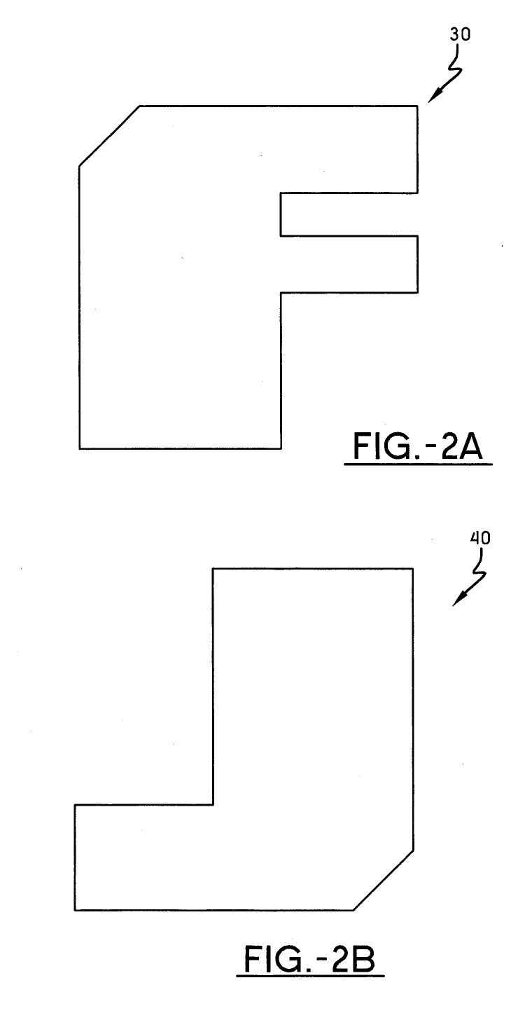

With reference to top plan view FIG. 2A, one embodiment of a windshield washer nozzle cover 30, molded in the form of a letter, is presented. It is noted that the windshield washer nozzle cover, when viewed from a perspective looking onto the external surface of the vehicle, completely conceals the nozzle. However, the cover is designed so as not to interfere with the function of the nozzle, which emits a spray of cleaning fluid directed onto the windshield when actuated by the user or driver as desired. FIG. 2B shows another embodiment of a windshield washer cover 40 as is possible in this invention. In the concept of the invention herein, the windshield washer nozzle cover may be molded in the form of indicia which include letters, numbers, symbols, characters, emblems, insignia, logos, tokens, and combinations thereof. The windshield washer nozzle cover may be molded in the form of any indicia, for the purpose of this invention, defined further herein as discriminating marks, signs, or tokens. In addition, the windshield washer nozzle cover of this invention may be further painted, etched or engraved. When, as is often the case, more than one windshield washer nozzle is disposed on or above the external surface of the vehicle, this invention may advantageously provide for the use of windshield washer nozzle covers of similar or different molded forms or alternative outward appearances, so as to satisfy the customized look sought by the vehicle owner or user and to provide non-verbal communication to others. In embodiments where two windshield washer nozzles are disposed on the vehicle, the windshield washer nozzle covers can express non-verbal communication to others by a set or series of numbers, letters, or even words. Thus, in one embodiment, the two covers can provide for a two-digit number, such as 01 or 10. In another embodiment, the two covers can provide for a two-letter code, such as FJ or HI. In yet another embodiment, the two covers can provide for a two-word phrase, such as HOT and ROD, or LOOKS and GREAT.

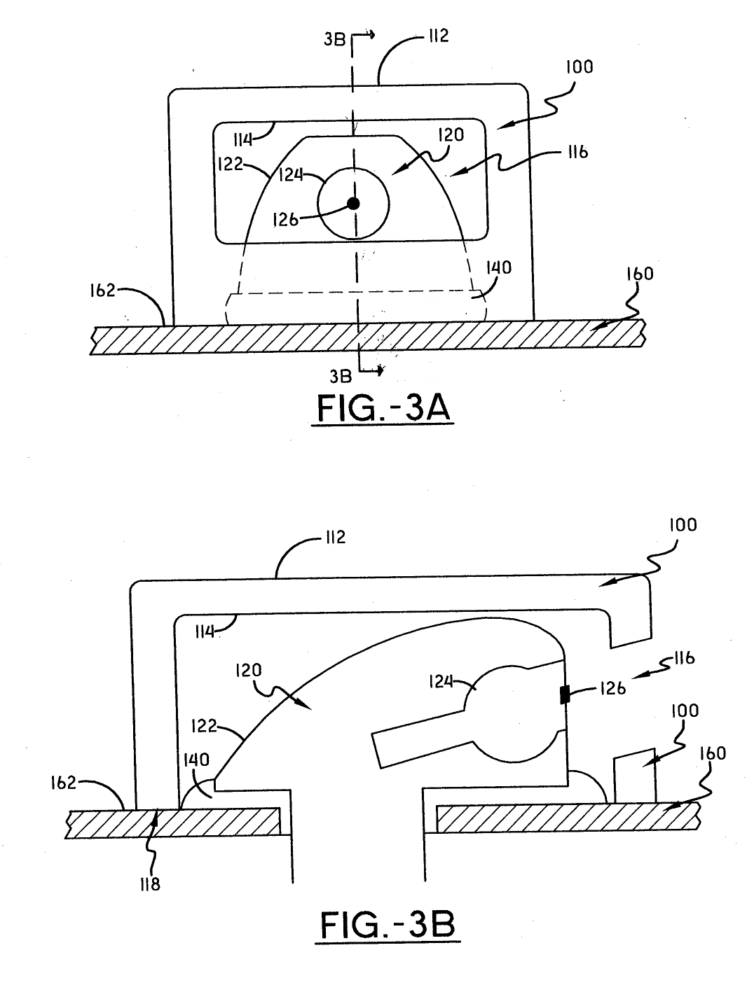

FIG. 3A represents a front elevation view into the windshield washer nozzle cover, generally depicted by the numeral 100, featuring a window or opening, generally identified by the numeral 116, the cover 100 being mounted over a windshield washer nozzle, generally depicted by the numeral 120. For example, the driver of a vehicle may observe the windshield washer nozzle cover in this manner if seated in the vehicle and looking through the windshield out toward the surface of the hood of the vehicle. The windshield washer nozzle cover for concealing an external windshield washer nozzle having a spray outlet and disposed on the exterior surface of a vehicle, has an interior surface 114 defining a cavity to accommodate the windshield washer nozzle and an exterior surface 112 having a contour different than that of the windshield washer nozzle. The windshield washer nozzle cover exterior surface 112, while being shown as being substantially planar, may be contemplated so that the exterior surface 112 may be configured to have any suitable surface contour or shape, and may be in the form of indicia including but not limited to letters, numbers, symbols, characters, emblems, insignia, logos, tokens, and combinations thereof. The exterior surface 112 may be additionally etched or engraved to further enhance the appearance of the exterior surface 112. Moreover, the windshield washer nozzle cover 100 may be configured to have any sectional shape suitable for attaching the cover 100 to the body 160 of the vehicle. The vehicle body 160 could, for example, be the hood of the vehicle.

In one embodiment, the windshield washer nozzle cover 100 further includes the interior surface 114 which may be shaped as shown planar or, alternatively, may be shaped to any suitable contour or shape designed to maintain clearance for the cover 100 to fit over the windshield washer nozzle assembly 120. In other words, the interior surface 114 is shaped to define a cavity that accommodates the windshield washer nozzle assembly 120 having a nozzle assembly body exterior surface 122. The interior surface 114 may have a contour complementary to a contour of the windshield washer nozzle, or as in the embodiment shown in FIG. 3B, a contour different than that of the windshield washer nozzle exterior surface 122. It may also be envisioned that the windshield washer nozzle cover interior surface 114 may have a contour complementary to the contour of the exterior surface 112 of the windshield washer nozzle cover 100.

Further depicted in the embodiment shown in FIGS. 3A and 3B, the windshield washer nozzle cover 100 includes an opening or a window 116 in which the windshield washer nozzle member 124 may communicate with the atmosphere, thereby providing an uninhibited path for directing the cleaning fluid onto the windshield of the vehicle. Further, the nozzle member 124 may be spherical, oblong, or any other shape as determined by the manufacturer of the nozzle assembly. Likewise, the window 116 of the windshield washer nozzle cover 100 may be in any shape, including rectangular, spherical, or oblong, to accommodate the particular design of the windshield washer nozzle member 124 of the windshield washer nozzle assembly 120. The windshield washer nozzle assembly 120 further includes at least one nozzle orifice 126 which emits cleaning fluid spray to be directed onto the outer windshield surface (not shown). The windshield washer nozzle assembly 120 may also include a rubber gasket 140 or another means of fitting the nozzle assembly into the vehicle body 160. The vehicle body has a vehicle body external surface 162, which may be planar or contoured; the surface being finished, painted, or metallic as is known in the art. The vehicle body external surface 162 may be the hood of a vehicle.

In the sectional side view of this embodiment along line 3B-3B of FIG. 3A, it will be appreciated that any means of attaching the windshield washer nozzle cover 100 may be used. An edge surface 118 communicates between the interior surface 114 and the exterior surface 112 and defines the periphery of the interior surface and the exterior surface and also an opening to permit the spray outlet or orifice 126 of the windshield washer nozzle 120 to emit fluid. The portion of the edge surface 118 of the windshield washer nozzle cover 100 defining the periphery of the interior and exterior surfaces and which comes in contact with the vehicle body external surface 162, may be attached to the vehicle body external surface 162 by any fastening means, such as employing adhesive to the edge surface 118. The adhesive may be any tape, glue, or combination thereof. In one embodiment, the edge surface 118 of windshield washer nozzle cover 100 may utilize a suitable adhesive in which the user can peel away a paper or plastic film to expose the adhesive for direct application onto the vehicle body external surface 162. In one or more other embodiments, it will be appreciated that any means of attaching the windshield washer nozzle cover 100 to the vehicle body 160 may be used. Adhesives, tapes, and other fastening means known in the art may be used in alternative embodiments of the present invention. It may also be envisioned, in an embodiment in which the interior surface 114 is complementary to the windshield washer nozzle exterior surface 122, that the windshield washer nozzle cover interior surface 114 may have an adhesive attached so that the nozzle cover attaches directly to the nozzle itself; thereby the need to attach the cover 100 to the vehicle external surface 160 is eliminated, if so desired.

Further in the view depicted in FIG. 3B, it is noted that the windshield washer nozzle cover window 116 is configured so as to leave open and exposed the portion of the cover which is in line with the nozzle member 124 of the windshield washer nozzle assembly 120. At least one orifice 126 has a direct and free pathway to emit a fluid onto the external surface of the vehicle's windshield. Further, as depicted in this view, it may be appreciated that the interior surface 114 of the windshield washer nozzle cover 100 needs only to be accommodating with respect to the exterior surface 122 of the windshield washer nozzle assembly 120. The interior cavity as defined by the interior surface 114 accommodates the windshield washer nozzle assembly 120.

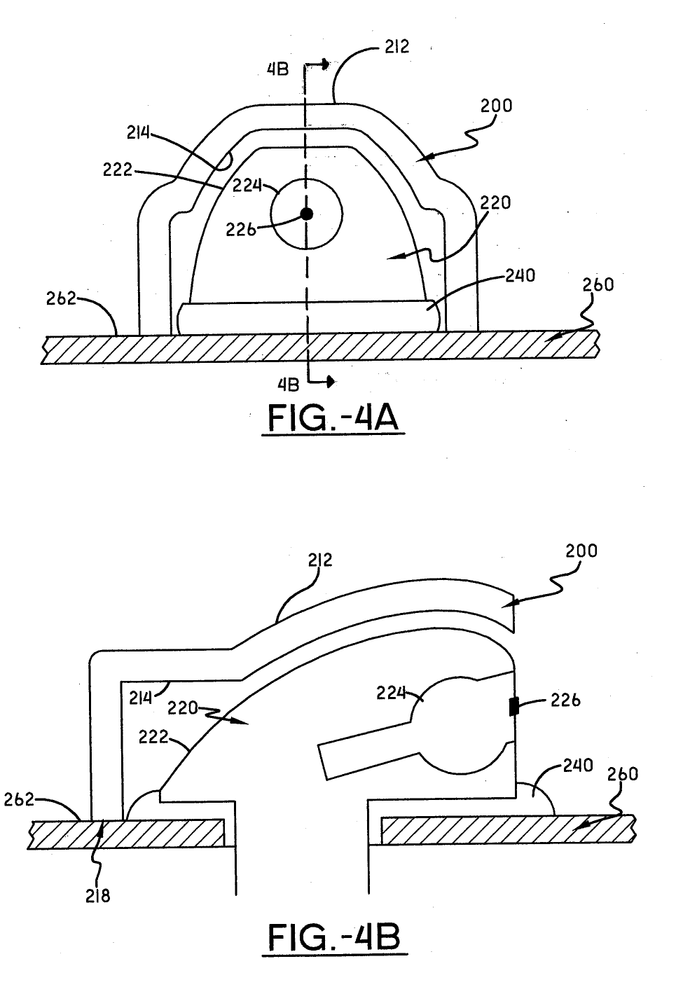

In the embodiment depicted in front elevation view FIG. 4A looking into the windshield washer nozzle cover 200, the windshield washer nozzle cover 200 is configured such that there is no front of the cover, in other words, the front side is left fully open rather than incorporating a window as in the previous embodiment. Thus, in the embodiment shown, the windshield washer nozzle 220 is covered around three sides of its perimeter with the nozzle cover 200, but is exposed on its fourth side so that the nozzle member 224, which includes at least one nozzle orifice 226, functions as purposed to emit cleaning fluid directed onto the windshield of the vehicle. However, the windshield washer nozzle cover 200 conceals the windshield washer nozzle assembly 220 from those looking onto the surface of the vehicle. The representative embodiment shown in FIGS. 4A and 4B shows a generally rectangular symbol structure. It will be appreciated that this structure is for illustrative purposes only and is not limiting of the present invention.

The windshield washer nozzle cover 200 comprises an exterior surface 212, which may be planar or suitably contoured, and may be molded in the form of indicia, including but not limited to letters, numbers, symbols, characters, emblems, insignia, logos, tokens, and combinations thereof. The cover may be further painted, etched or engraved. The nozzle cover 200 further comprises an interior surface 214, which may also be planar or suitably contoured, such that the interior surface defines a cavity that accommodates the nozzle assembly body exterior surface 222. The windshield washer nozzle assembly 220 may further include a rubber gasket 240 or other means to insert and secure the windshield washer nozzle assembly into the vehicle body 260, such as a hood. The windshield washer nozzle cover 200 is adhered to the vehicle body 260 by means of attaching the nozzle cover 200 to the vehicle body external surface 262, which may be painted or metallic or any material used and known in the art to cover the external surface of a vehicle.

In a representative sectional side view of this embodiment, as shown in FIG. 4B, it is further demonstrated that the windshield washer nozzle cover 200 functions to conceal the windshield washer nozzle assembly 220 without impeding the purposed function of the nozzle to deliver fluid to the windshield of the vehicle as deemed necessary by the vehicle operator. Further in the view depicted in FIG. 4B, it is noted that the windshield washer nozzle cover 200 leaves, as shown at the right side of the Figure, the front side or portion of the nozzle cover open, thereby, exposing the nozzle member 224 of the windshield washer nozzle assembly 220. At least one nozzle orifice 226 has a direct and uninhibited pathway to emit a fluid onto the external surface of the vehicle's windshield.

The edge surface 218, specifically the portion which comes in contact with the vehicle body external surface 262, of the windshield washer nozzle cover 200 may be attached to the vehicle body external surface 262 by any fastening means, such as employing tape or adhesive. In a preferred embodiment, the edge surface 218 of windshield washer nozzle cover 200 may utilize a suitable adhesive in which the user can peel away a paper or plastic film to expose the adhesive for direct application onto the vehicle body external surface 262. In other embodiments, it will be appreciated that any means of attaching the windshield washer nozzle cover 200 to the vehicle body 260 may be used. Adhesives, tapes, and other fastening means known in the art may be used in alternative embodiments of the present invention. It may also be envisioned that the windshield washer cover 200, in an embodiment having an interior surface 214 contoured similarly to the nozzle exterior surface 222, may be adhered directly onto the windshield washer nozzle itself by applying an adhesive to the interior surface 214 and then pressing onto the nozzle exterior surface 222; thereby the need to attach the nozzle to the vehicle external surface is eliminated, if so desired.

As represented by these embodiments detailed within, the exterior surface of the windshield washer nozzle cover may take on many forms. The interior surface of the windshield washer nozzle cover may also take on many forms, which may be open or contoured to fit around a windshield washer nozzle assembly. The windshield washer nozzle cover may be open on one side, or alternatively include a window or opening, in order for the windshield washer nozzle to function uninhibited. The windshield washer nozzle cover may be in the form of indicia, including but not limited to letters, numbers, symbols, characters, emblems, insignia, logos, tokens, and combinations thereof. The windshield washer nozzle cover may further be engraved or etched.

Also envisioned as one embodiment of the present invention, a vehicle comprising two windshield washer nozzles, being spaced apart, may each have a windshield washer nozzle cover molded into a shape different than the contour of the windshield washer nozzle. The molded cover, configured in the form of indicia such as letters, numbers, symbols, characters, emblems, insignia, logos, tokens, and combinations thereof, provide non-verbal communication to others. It may further be envisioned that each of the windshield washer nozzle covers disposed on the vehicle may be molded into a shape different from any other windshield washer nozzle cover on the vehicle, such that all of the windshield washer nozzle covers combined provide non-verbal communication to others. In other words, it may also be appreciated, wherein more than one nozzle is disposed on a vehicle, the windshield washer nozzle covers to conceal the nozzles may be of similar or different shapes or forms, thus providing a custom look as desired by the vehicle's owner or user.

It will, therefore, be appreciated that one advantage of one or more embodiments of the present invention is that a windshield washer nozzle cover is provided to conceal an exposed and protruding windshield washer nozzle of a vehicle's external surface, often the hood of a vehicle, with a cover having a shape different than that of the windshield washer nozzle. The windshield washer nozzle cover of the invention is easily constructed of widely available materials, and may thus be manufactured very economically. The present attachment, therefore, offers a simple and affordable alternative for the owner or operator of a vehicle to provide non-verbal communication to others while also protecting the nozzle(s) from weathering, tampering, or physical damage.

Although the present invention has been described in considerable detail with reference to certain embodiments, other embodiments are possible. For example, the molded shapes and configurations utilized could be the molded housing of the windshield washer nozzle itself. Such a nozzle would include a housing molded into a shape, wherein the shape is configured in the form of indicia to provide non-verbal communication to others. The indicia could be selected from the group consisting of letters, numbers, symbols, characters, emblems, insignia, logos, tokens, and combinations thereof. In one embodiment, the housing may have an exterior surface that could be painted, etched or engraved with additional indicia into the exterior surface. In another embodiment, the molded housing of the nozzle could be subjected to a treatment, the treatment selected from the group consisting of coloring, texturizing, coating, and combinations thereof.

Thus, based upon the foregoing, it will be appreciated that the concepts described above provide an improvement in the art. In particular, it should now be evident that a windshield washer nozzle cover, or as noted above, even a nozzle housing, of the present invention may provide a facile means of non-verbal communication to others.

Thus, it can be seen that one or more aspects of the invention have been satisfied by the structure and methods provided above. In accordance with the Patent Statutes, only the best mode and certain alternative embodiments have been presented in the application and described in any detail. It should be understood that the spirit and scope of the appended claims should not be limited to the description of the embodiments contained herein, the true scope and breadth of the invention being defined by the claims as follows.

What is claimed is:

1. A windshield washer nozzle cover for concealing an external windshield washer nozzle disposed on the exterior surface of a vehicle, the windshield washer nozzle cover being molded into a shape different than the contour of the windshield washer nozzle, wherein the shape is configured in the form of indicia to provide non-verbal communication to others.

2. The windshield washer nozzle cover of claim 1, wherein the indicia is selected from the group consisting of letters, numbers, symbols, characters, emblems, insignia, logos, tokens, and combinations thereof.

3. The windshield washer nozzle cover of claim 1, wherein the windshield washer nozzle cover includes an exterior surface painted, etched or engraved with additional indicia into the exterior surface.

4. The windshield washer nozzle cover of claim 1, wherein the cover is molded from a material selected from the group consisting of aluminum, steel and plastic that is capable of protecting the windshield washer nozzle from exposure to the environment.

5. The windshield washer nozzle cover of claim 4, wherein the cover is molded from billet aluminum.

6. The windshield washer nozzle cover of claim 4, wherein the cover is molded from plastic or steel, and wherein the molded cover has been subjected to a treatment, the treatment selected from the group consisting of coloring, texturizing, coating, and combinations thereof.

7. A windshield washer nozzle cover for concealing an external windshield washer nozzle having a spray outlet and disposed on the exterior surface of a vehicle, the windshield washer nozzle cover comprising:
an interior surface defining a cavity to accommodate the windshield washer nozzle;
an exterior surface having a contour different than that of the windshield washer nozzle, wherein the contour is configured in the form of indicia to provide non-verbal communication to others; and
an edge surface communicating between the interior surface and the exterior surface and defining the periphery of the interior surface and the exterior surface and an opening to permit the spray outlet of the windshield washer nozzle to emit fluid.

8. The windshield washer nozzle cover of claim 7, wherein the interior surface has a contour complementary to a contour of the windshield washer nozzle.

9. The windshield washer nozzle cover of claim 7, wherein the interior surface has a different contour than that contour of the windshield washer nozzle.

10. The windshield washer nozzle cover of claim 7, wherein the interior surface has a contour complementary to the contour of the exterior surface of the windshield washer nozzle cover.

11. The windshield washer nozzle cover of claim 7, wherein the indicia is selected from the group consisting of letters, numbers, symbols, characters, emblems, insignia, logos, tokens, and combinations thereof.

12. The windshield washer nozzle cover of claim 7, further comprising an adhesive on the edge surface defining the periphery of the interior and exterior surfaces for attaching the windshield washer nozzle cover to the exterior surface of the vehicle.

13. The windshield washer nozzle cover of claim 12, wherein the adhesive is selected from the group consisting of tape, glue, and combinations thereof.

14. The windshield washer nozzle cover of claim 8, further comprising an adhesive disposed on the interior surface of the nozzle cover, wherein the adhesive attaches the complementary interior surface of the nozzle cover to the windshield washer nozzle.

15. A vehicle comprising at least two windshield washer nozzles, the windshield washer nozzles being spaced apart, each windshield washer nozzle having a windshield washer nozzle cover molded into a shape different than the contour of the windshield washer nozzle, wherein the shape is configured in the form of indicia to provide non-verbal communication to others.

16. The vehicle of claim 15, wherein each windshield washer nozzle cover is molded into a shape different from any other windshield washer nozzle cover, such that all of the windshield washer nozzle covers combined provide a non-verbal communication to others.

17. A windshield washer nozzle comprising a housing molded into a shape, wherein the shape is configured in the form of indicia to provide non-verbal communication to others.
